(19) United States
(12) Patent Application Publication
(10) Pub. No.: US 2025/0330636 A1
(43) Pub. Date: Oct. 23, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai ZHANG, Los Angeles, CA (US); Zhipin DENG, Beijing (CN); Li ZHANG, Beijing (CN)

(21) Appl. No.: 19/258,865

(22) Filed: Jul. 2, 2025

Related U.S. Application Data
(63) Continuation of application No. PCT/CN2023/142992, filed on Dec. 28, 2023.

(30) Foreign Application Priority Data
Jan. 3, 2023 (WO) PCT/CN2023/070162

(51) Int. Cl. H04N 19/513; H04N 19/105; H04N 19/139; H04N 19/176; H04N 19/54

(52) U.S. Cl. CPC H04N 19/521; H04N 19/105; H04N 19/139; H04N 19/176; H04N 19/54

(57) ABSTRACT

Embodiments of the present disclosure provide a solution for video processing. A method for video processing is proposed. In the method, for a conversion between a current video block of a video and a bitstream of the video, a set of control point motion vectors (CPMVs) associated with an affine motion candidate of the current video block is determined. A refined affine motion candidate is determined by applying a refinement process to at least one CPMV in the set of CPMVs based on template matching. The conversion is performed based on the refined affine motion candidate.

### CROSS REFERENCE TO RELATED APPLICATIONS

This application is a continuation of International Application No. PCT/CN2023/142992, filed on Dec. 28, 2023, which claims the benefit of International Application No. PCT/CN2023/070162 filed on Jan. 3, 2023. The entire contents of these applications are hereby incorporated by reference in their entireties.

### FIELDS

Embodiments of the present disclosure relates generally to video processing techniques, and more particularly, to affine motion candidate refinement.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a set of control point motion vectors (CPMVs) associated with an affine motion candidate of the current video block; determining a refined affine motion candidate by applying a refinement process to at least one CPMV in the set of CPMVs based on template matching; and performing the conversion based on the refined affine motion candidate. The method in accordance with the first aspect of the present disclosure refines the affine motion candidate and the CPMV. In this way, the coding efficiency and coding effectiveness can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a set of control point motion vectors (CPMVs) associated with an affine motion candidate of a current video block of the video; determining a refined affine motion candidate by applying a refinement process to at least one CPMV in the set of CPMVs based on template matching; and generating the bitstream based on the refined affine motion candidate.

In a fifth aspect, a method for storing a bitstream of a video is proposed. The method comprises: determining affine motion compensation information of a current video block of the video; determining a set of control point motion vectors (CPMVs) associated with an affine motion candidate of a current video block of the video; determining a refined affine motion candidate by applying a refinement process to at least one CPMV in the set of CPMVs based on template matching; generating the bitstream based on the refined affine motion candidate; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6A illustrates a 4-parameter control point based affine motion model;

FIG. 6B illustrates a 6-parameter control point based affine motion model;

FIG. 7 illustrates an affine MVF per subblock;

FIG. 8 illustrates locations of inherited affine motion predictors;

FIG. 9 illustrates control point motion vector inheritance;

FIG. 10 illustrates locations of candidates position for constructed affine merge mode;

FIG. 11 illustrates spatial neighbors for deriving affine merge candidates, where (a) in FIG. 11 is for deriving inherited affine merge candidates, and (B) in FIG. 11 is for deriving constructed affine merge candidates;

FIG. 12 illustrates a diagram from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performing on a search area around initial MV;

FIG. 16 illustrates a template and the corresponding reference template;

FIG. 17 illustrates a template and reference template for block with subblock motion using the motion information of the subblocks of current block;

FIG. 18 illustrates a diagram showing deriving sub-CU motion field obtained by applying a motion shift based on the neighboring motion information;

FIG. 19 illustrates a flowchart of a method for video processing in accordance with embodiments of the present disclosure; and

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

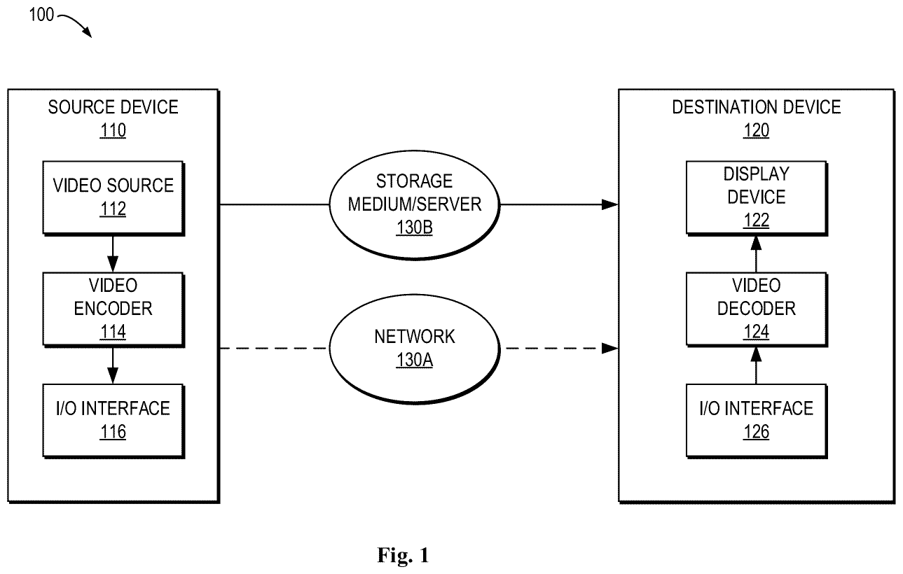

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

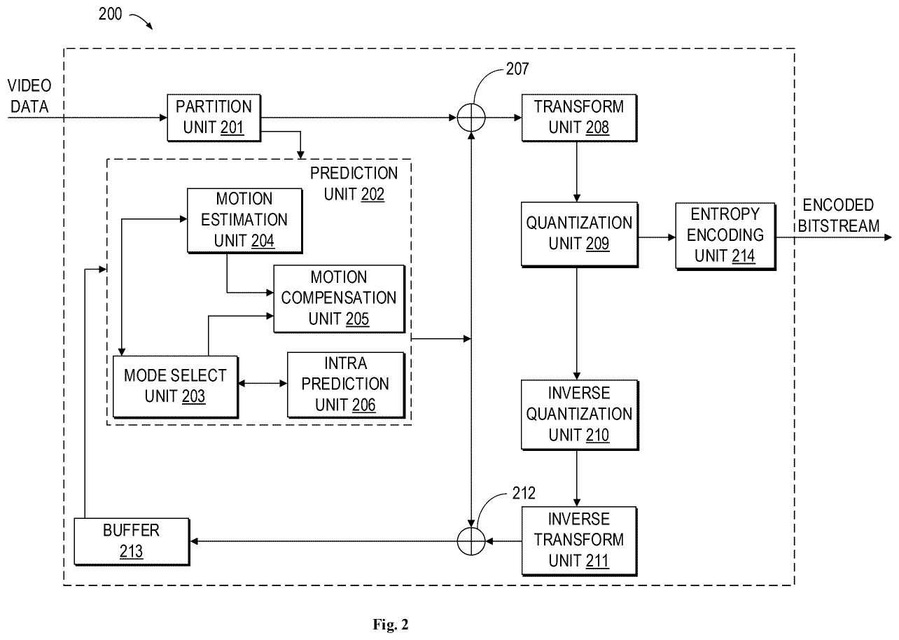

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

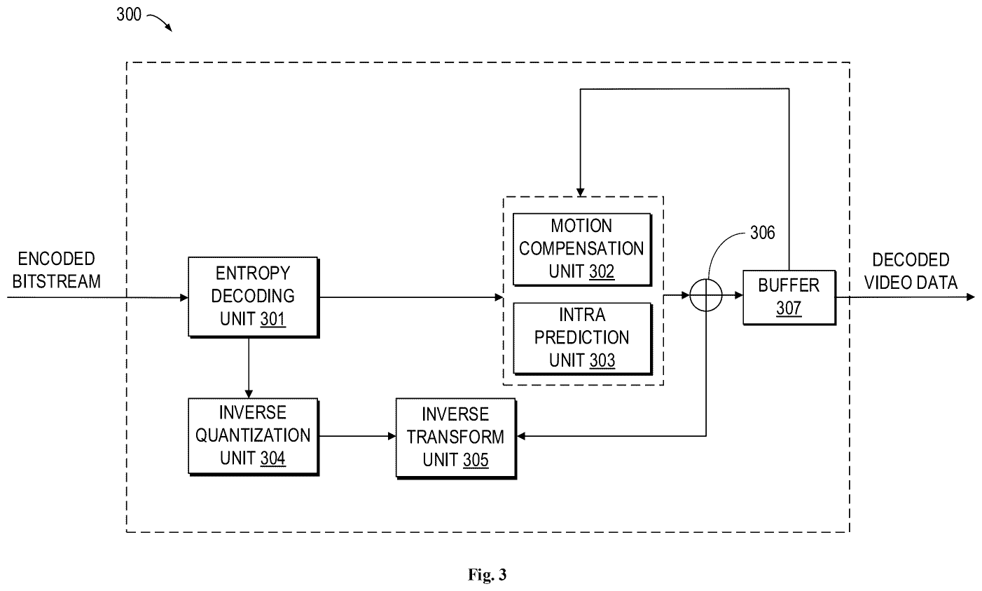

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is about Affine motion prediction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates a diagram 400 of positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list. Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

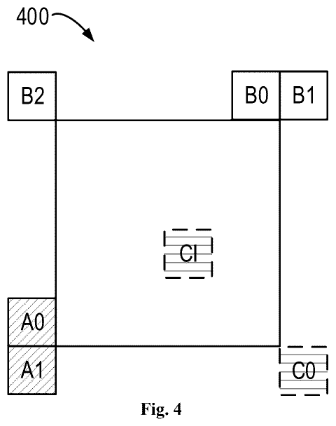

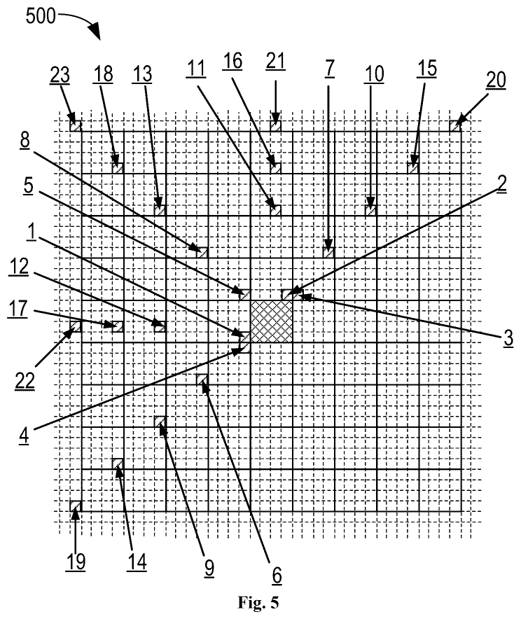

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 5, which illustrates a diagram 500 of positions of non-adjacent candidate in ECM.

### 2.2. Affine Motion Compensated Prediction

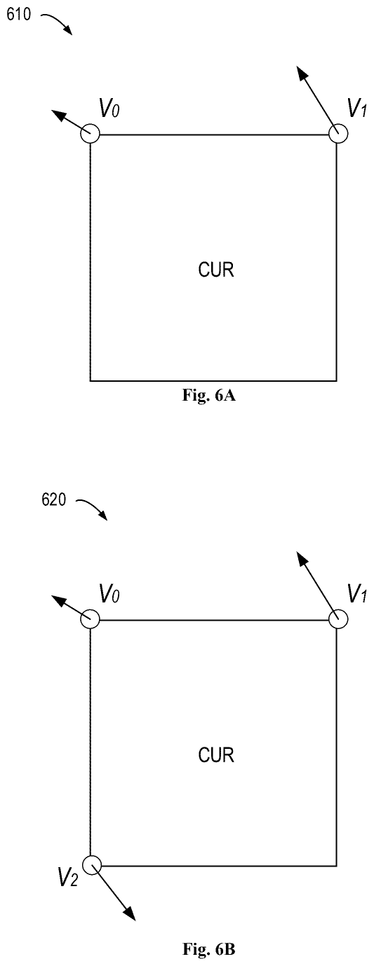

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 6A illustrates a diagram 610 of a 4-parameter control point based affine motion model. FIG. 6B illustrates a diagram 620 of a 6-parameter control point based affine motion model. As shown in FIG. 6A and FIG. 6B, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} . \qquad ( 1 )$$

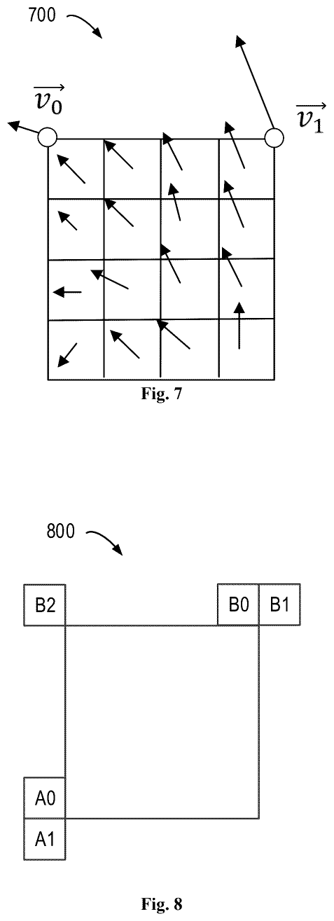

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 x}}{H} y + {mv}_{0 y}\end{matrix} . \qquad ( 2 )$$

Where (mv0x, mv0y) is motion vector of the top-left corner control point, (mv1x, mv1y) is motion vector of the top-right corner control point, and (mv2x, mv2y) is motion vector of the bottom-left corner control point. FIG. 7 illustrates an example diagram 700 of affine MVF per subblock. In order to simplify the motion compensation prediction, block based affine transform prediction is applied. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region. As done for translational motion inter prediction, there are also two affine motion inter prediction modes: affine merge mode and affine AMVP mode.

### 2.2.1. Affine Merge Prediction

Affine merge mode can be applied for CUs with both width and height larger than or equal to 8. In this mode the CPMVs of the current CU is generated based on the motion information of the spatial neighboring CUs. There can be up to five CPMVP candidates and an index is signaled to indicate the one to be used for the current CU. In VVC, the following three types of CPVM candidate are used to form the affine merge candidate list:
Inherited affine merge candidates that extrapolated from the CPMVs of the neighbour CUs,
Constructed affine merge candidates CPMVPs that are derived using the translational MVs of the neighbour CUs,
Zero MVs

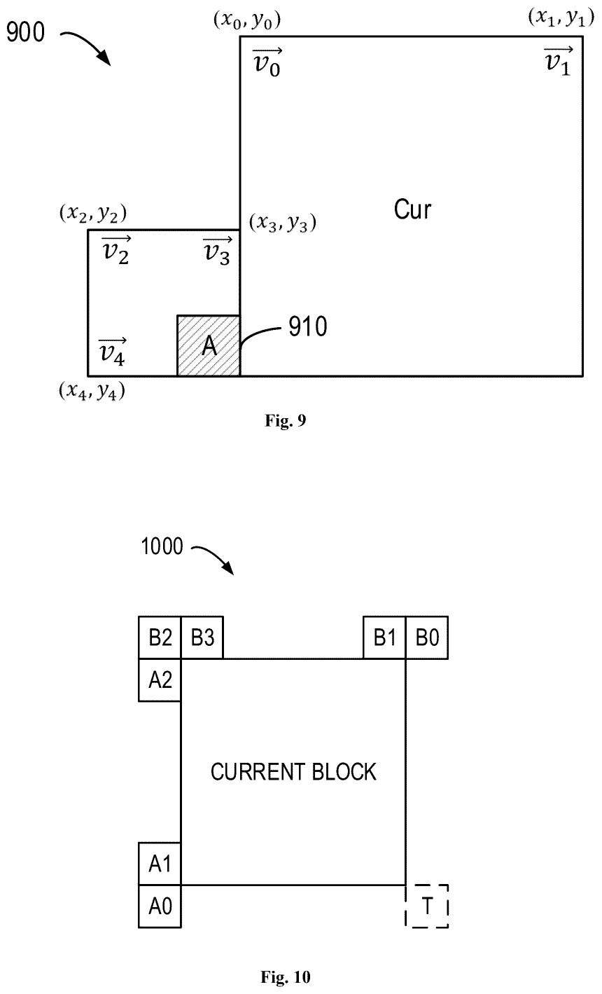

In VVC, there are maximum two inherited affine candidates, which are derived from affine motion model of the neighboring blocks, one from left neighboring CUs and one from above neighboring CUs. FIG. 8 illustrates an example 800 of locations of inherited affine motion predictors. The candidate blocks are shown in FIG. 8. For the left predictor, the scan order is A0→A1, and for the above predictor, the scan order is B0→B1→B2. Only the first inherited candidate from each side is selected. No pruning check is performed between two inherited candidates. When a neighboring affine CU is identified, its control point motion vectors are used to derive the CPMVP candidate in the affine merge list of the current CU. FIG. 9 illustrates an example diagram 900 of control point motion vector inheritance. As shown in FIG. 9, if the neighbour left bottom block A 910 is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbor translational motion information of each control point. FIG. 10 illustrates a diagram 1000 of locations of Candidates position for constructed affine merge mode. The motion information for the control points is derived from the specified spatial neighbors and temporal neighbor shown in FIG. 10. CPMVk (k=1, 2, 3, 4) represents the k-th control point. For CPMV1, the B2→B3→A2 blocks are checked and the MV of the first available block is used. For CPMV2, the B1→B0 blocks are checked and for CPMV3, the A1→A0 blocks are checked. For TMVP is used as CPMV4 if it's available.

After MVs of four control points are attained, affine merge candidates are constructed based on those motion information. The following combinations of control point MVs are used to construct in order: {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.2.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs,
Constructed affine AMVP candidates CPMVPs that are derived using the translational MVs of the neighbour CUs,
Translational MVs from neighboring CUs,
Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable. If affine AMVP list candidates is still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3. New Affine Candidates Derivation Methods in ECM-6.0

In ECM-6.0, 3 additional Affine merge and AMVP candidate derivation methods are integrated, which are Non-adjacent spatial candidates, History-parameter-based candidates and Regression based affine candidates.

### 2.2.3.1. Non-Adjacent Spatial Candidates

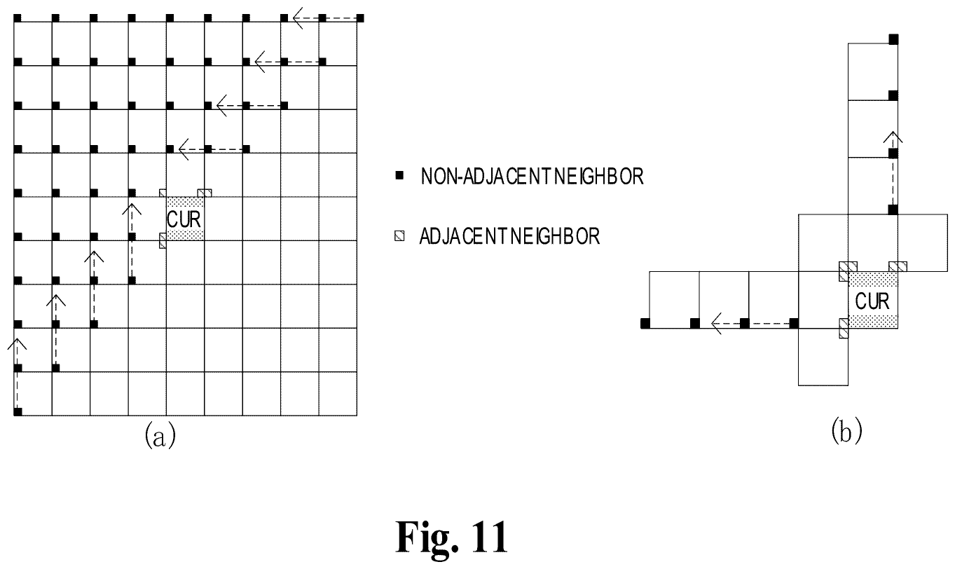

In ECM-6.0, non-adjacent spatial neighbors are investigated to provided candidates for both Affine merge and Affine AMVP. FIG. 11 illustrates of spatial neighbors for deriving affine merge candidates. The pattern of obtaining non-adjacent spatial candidates is shown in FIG. 11. Same as the non-adjacent regular merge candidates, the distances between non-adjacent spatial candidates and current coding block are also defined based on the width and height of current CU.

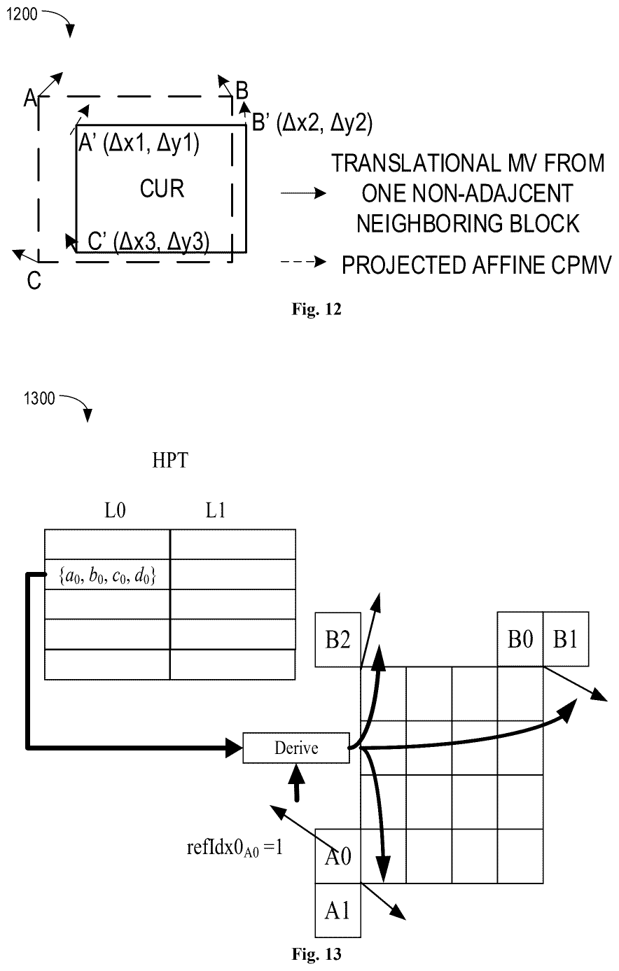

The motion information of the non-adjacent spatial neighbors in FIG. 11 is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in (a) of FIG. 11, the checking of the neighbors on the left and above sides are performed from bottom-to-up and right-to-left, respectively. For constructed candidates, as shown in the (b) of FIG. 11, the positions of one left and above non-adjacent spatial neighbors are firstly determined independently; After that, the location of the top-left neighbor can be determined accordingly to form a rectangular virtual block together with the left and above non-adjacent neighbors. FIG. 12 illustrates a diagram 1200 from non-adjacent neighbors to constructed affine merge candidates. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12.

### 2.2.3.2. History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formulary way, the category of HPT (denoted as HPTCat) is calculated as

$$HPTCat ( RefList , RefIdx ) = 5 \times RefList + min ( RefIdx , 4 ) \qquad ( 3 )$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and RefIdxcur, the affine parameters are utilized to update entries in the category HPTCat (RefListcur, RefIdxcur) in a way similar to HMVP table updating.

FIG. 13 illustrates an example diagram 1300 of generating an HAPC. A history-affine-parameter-based candidate (HAPC) is derived from a neighbouring 4×4 block denoted as A0, A1, B0, B1 or B2 in FIG. 13 and a set of affine parameters stored in a corresponding entry in HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} , \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows how to derive an HAPC from block A0. The affine parameters {a0, b0, c0, d0} are directly fetched from one entry of category HPTIdx(RefListA0, refIdx0A0) in HPT. The affine parameters from HPT, with the center position of A0 as the base position, and the MV of block A0 as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

### 2.2.3.3. Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

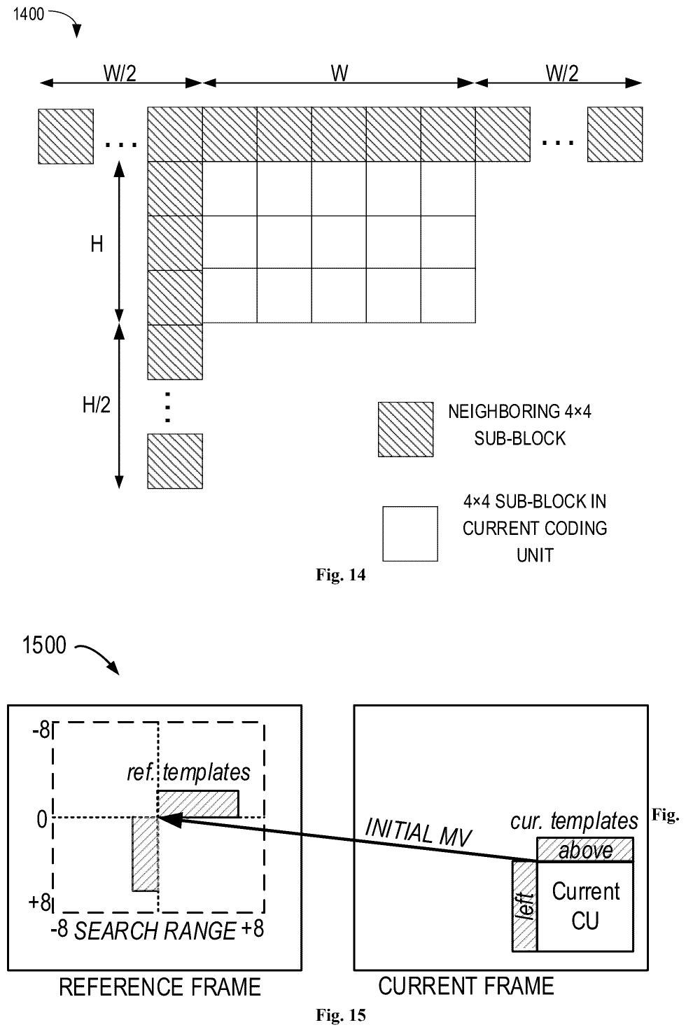

The previously coded affine CU can be identified from scanning through non-adjacent positions and the affine HMVP table. FIG. 14 illustrates an illustration 1400 of regression based affine merge candidate derivation. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

### 2.3. Template Matching Merge/AMVP Mode in ECM

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. FIG. 15 illustrates a diagram 1500 of template matching performing on a search area around initial MV. As illustrated in FIG. 15, a better MV is to be searched around the initial motion of the current CU within a [−8, +8]-pel search range.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

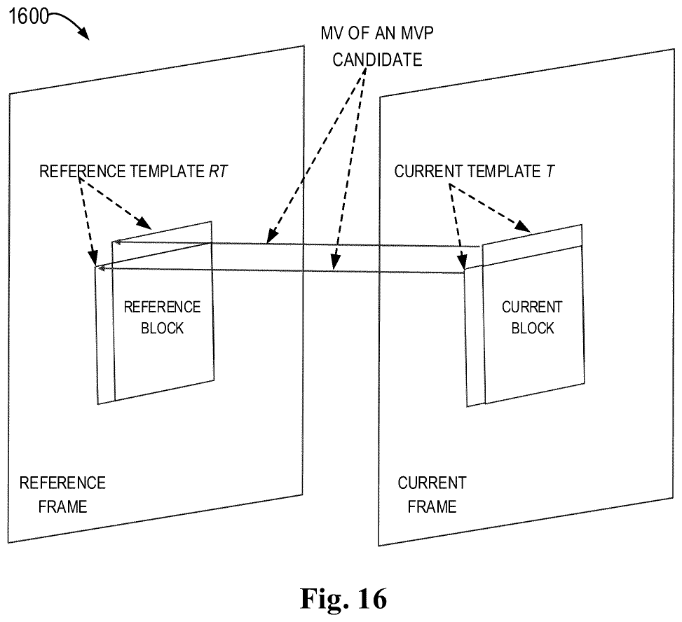

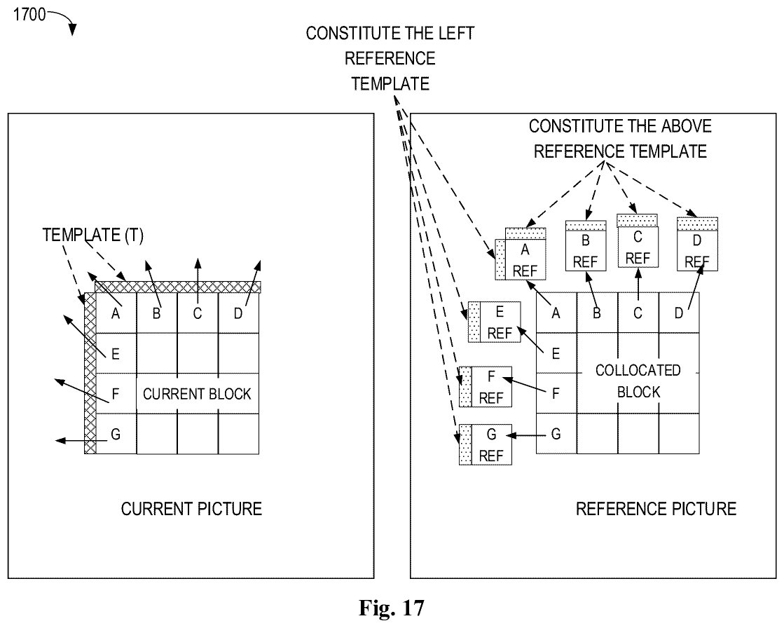

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered. The template matching cost is measured by the sum of absolute differences (SAD) between samples of a template of the current block and their corresponding reference template. FIG. 16 illustrates a diagram 1600 of template and the corresponding reference template. The template comprises a set of reconstructed samples neighboring to the current block, while reference template is located by the same motion information of the current block, as illustrated in FIG. 16. When a merge candidate utilizes bi-directional prediction, the reference samples of the template of the merge candidate are also generated by bi-prediction.

For subblock-based merge candidates with subblock size equal to Wsub*Hsub, the above template comprises several sub-templates with the size of Wsub×K, and the left template comprises several sub-templates with the size of K×Hsub. FIG. 17 illustrates a diagram 1700 of template and reference template for block with sub-block motion using the motion information of the subblocks of current block. As shown in FIG. 17. the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTVMP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

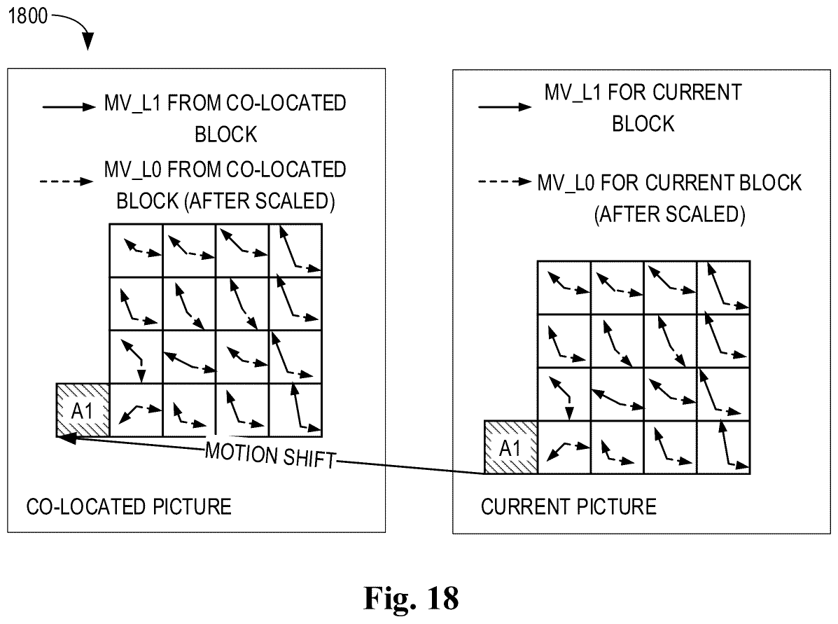

FIG. 18 illustrates the derivation process 1800 of the sub-block level motion field for SbTMVP. In particular, the motion information of left-bottom sub-block A1 is firstly fetched, if either of the MVs in reference list0 and list1 points to the collocated frame, then the corresponding MV will be identified as motion shift. Otherwise, zero mv will be used as motion shift.

Once the motion shift is determined, the specified regions in the collocated frame is employed to derive sub-block level motion field. Assuming A1′ motion is used as motion shift as depicted in FIG. 18. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

FIG. 18 illustrates deriving sub-CU motion field obtained by applying a motion shift based on the neighboring motion information.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 3. Problems

CPMV is critical for Affine motion compensation since it provides basic motion information for all the sub-blocks within the block. In existing CPMV derivation methods, however, the CPMV of the current block is estimated as the MV of an already-coded block, which may not guarantee the coherence with the true motion. Therefore, a CPMV refinement method is highly desired to reduce the deviation between the estimated CPMV and the true motion.

### 4. Detailed Solutions

In this disclosure, it is proposed to refine Affine CPMV with template matching. For a given Affine candidate in Affine candidate list, the CPMV may be further refined with template matching, and the refined Affine candidate is then used to derive sub-block or pixel level Affine motion information for the current block.

The detailed embodiments below should be considered as examples to explain general concepts. These embodiments should not be interpreted in a narrow way. Furthermore, these embodiments can be combined in any manner.

The terms “video unit” or ‘coding unit’ or ‘block’ may represent a coding tree block (CTB), a coding tree unit (CTU), a coding block (CB), a CU, a PU, a TU, a PB, a TB.

The terms ‘Affine block’ may represent a block coded with Affine merge, Affine AMVP or any other Affine variant mode (i.e., Affine MMVD etc), which may be described by motion information of two control point (4-parameter) or three control point motion vectors (6-parameter). The terms ‘CPMV’ may represent the motion information of an Affine block at top-left, top-right and/or bottom-left corners.

The term “template” may represent a reconstructed region that can be used to refine the CPMV, which may represent either ‘separate template’ or ‘unified template”. Here a ‘separate template’ may represent a reconstructed region that can be used to refine individual CPMV, i.e., specific one(s) of top-left, top-right and/or bottom-left corners, while a ‘unified template’ may represent a reconstructed region that can be used to refine all or arbitrary CPMV(s) for a block. The term “template matching cost” or ‘TM cost’ may represent either matching cost of a separate template or a unified template.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.
1. In one example, affine motion compensation may be refined by using previously decoded samples.
   a) In one example, at least one CPMV may be refined.
   b) In one example, at least one MV of one subblock of affine motion compensation may be refined.
   c) In one example, at least one affine parameter (such as a, b, c, d, e, f) may be refined.
   d) In one example, previously decoded samples may be a template of the current block.
   e) In one example, previously decoded samples may be a template of the reference block.
   f) In one example, template represents a reconstructed region that can be used to refine the CPMV.
   g) In one example, for an Affine-coded block, different separate templates may be used for different control points.
      i. In one example, for a control point, the corresponding separate template may comprise the samples from the adjacent and/or non-adjacent positions in the already-reconstructed region.
         1) In one example, the separate templates for all the control points are collected from adjacent reconstructed region.
         2) In one example, the separate template samples for some control points are collected from the adjacent reconstructed region of the current block, while for the rest control points, the temple samples are collected from non-adjacent reconstructed region.
         a) In one example, specifically, the template samples for left-top corner are collected from non-adjacent region, while for right-top and/or left-bottom corners, the temple samples are collected from adjacent region.
         3) In one example, both adjacent and non-adjacent samples are used for certain control points.
      ii. In one example, for different control points, the shape of the separate templates may be different.
         1) In one example, for certain control points, L-shape (e.g., comprising both above and left neighbouring samples) separate template is used.
         2) In one example, for certain control points, I-shape or ‘-’ shape template (e.g., comprising either left or above (but not both) neighbouring samples) may be used.
      iii. In one example, which shape of template is used for a CPMV refinement may be based on the position/location of the control point.
         1) In one example, CPMV at the top-left corner of the current video unit may use a L-shape template (e.g., comprising both above and left neighbouring samples).
         2) In one example, CPMV at the top-right corner of the current video unit may use a ‘-’ shape template (e.g., comprising above neighbouring samples only).
         3) In one example, CPMV at the top-left corner of the current video unit may use a I-shape template (e.g., comprising left neighbouring samples only).
         4) In one example, for a certain CPMV, the shapes of templates in the current picture and reference picture are same.
         a) For example, as depicted in FIG. 16, the template of a CPMV may refer to a group of neighbouring samples in the current picture (e.g., templates in the current picture) and a second group of neighbouring samples in a reference picture (e.g., templates in the reference picture).
      iv. In one example, for different control points, the number of the samples used in the template may be different.
         1) Alternatively, the number of the sample used for different control points are the same for an Affine block.
         2) For different control points, the lines (or rows or columns) of the samples used in the template may be different.
   h) In one example, a unified template is used during the CPMV refinement.
      i. In one example, the TM cost associated with the unified template is used to determine the MV shift value.
      ii. In one example, the TM cost associated with the unified template is used to determine the CPMV combination.
      iii. In one example, a unified template may comprise all or partial adjacent samples of the whole block, i.e. as shown in FIG. 16.
   i) A template may only comprise samples from one component such as luma, or from multiple components such as luma and chroma.
   j) In one example, for arbitrary template, a reference template region with the same shape may be located with a MV, as shown in FIG. 16.
   k) In one example, a template may not necessarily contain all the pixels in a certain region, it may contain part of the pixels in the specified region.
2. When constructing an Affine candidate list, CPMV refinement may be firstly performed to a potential affine candidate, then the refined candidate is inserted into the Affine candidate list.
   a) In one example, alternatively, CPMV refinement is conducted after the Affine candidate list is constructed.
      i. In one example, only the Affine candidate(s) with specific index(es) need to perform CPMV refinement.
      ii. In one example, all or partial Affine candidates need to perform CPMV refinement.
3. In one example, a first Affine candidate list is constructed firstly, followed by a second Affine candidate list construction process.
   a) For example, the input of the second Affine candidate list generation may be based on the output of the first Affine candidate list generation.
   b) For example, the first Affine candidate list may be constructed without CPMV refinement.
   c) For example, the second Affine candidate list may be generated by applying CPMV refinement on the CPMV candidates in the first Affine candidate list.
      i. For example, at least one CPMV candidate in the first Affine candidate list may be refined.
      ii. Alternatively, more than one CPMV candidates in the Affine candidate list may be refined.
      iii. For example, the CPMV refinement may be based on TM.
   d) For example, the first Affine candidate list may be constructed with a candidate reordering process.
      i. For example, the reordering process may be based on TM.
   e) For example, the second Affine candidate list may be constructed without any candidate reordering process.
   f) For example, different pruning rules may be used in the first pruning and the second pruning.
      i. For example, the first Affine candidate list generation may be applied associated with a first pruning method.
      ii. For example, the second Affine candidate list generation may be applied associated with a second pruning method.
      iii. For example, the threshold for motion similarity checks in the first and second pruning methods may be different.
      iv. For example, a block dimension (e.g., block width and/or height) based threshold may be used in the second pruning method.
      V. For example, alternatively, a fixed threshold may be used in the second pruning method.
4. For a given Affine candidate, some or all of the CPMVs may be refined based on TM, then the refined CPMVs are used to derive the Affine motion information for the current block and/or sub-block(s).
   a) In one example, both integer and fractional precision may be used to refine the control points.
      i. In one example, only integer precision is used to refine the control point, and fractional precision searching is skipped.
         1) In one example, whether fractional precision search is needed depends on the results of integer precision search.
      ii. In one example, it is proposed to use a specific interpolation filter to generate reference templates for motion vectors pointing to fractional positions.
         1) In one example, a simplified interpolation filter may be applied.
         2) In one example, the simplified interpolation filter can be 2-tap bilinear, alternatively, it can also be 4-tap, 6-tap or 8-tap filter that belongs to DCT, DST, Lanczos or any other interpolation types.
         3) In one example, a more complex interpolation filter (e.g., with longer filter taps) may be applied.
      iii. In one example, whether to use above methods (e.g., integer precision, different interpolation filters) or not and/or how to use above methods can be signalled in the bitstream (such as in SPS, PPS, picture header, slice header, CTU, CU, etc.) or determined on-the-fly according to decoded information.
         1) In one example, which method to be applied may be dependent on the coding tool.
         2) In one example, which method to be applied may be dependent on block dimension.
b) In one example, different control points are respectively refined, which means the MV shift values (i.e., the difference between an initial CPMV and the corresponding refined CPMV) may be different for different control points.
   i. In one example, all or some of the control points may first be respectively refined by TM, then one combination of control points is determined by looping over all or some of the combinations (i.e. M (such as M=4) combinations for 4-parameter model, −N (such as N=8) combinations for 6-parameter model) of CPMVs before and after refinement, and one set of CPMVs that minimize the TM cost of the current block is derived.
      1) In one example, in above case, all or some of the control points may first be refined by the respective separate templates.
      2) In one example, for each combination of CPMVs, the sub-block level motion information is calculated for the boundary sub-blocks, then the unified TM cost is calculated in accordance with the method described in section 2.4 and FIG. 17. The optimal combination which yields the least TM cost is selected as the refined Affine candidate.
         a) In one example, only partial boundary sub-blocks need to calculate the TM cost.
      3) In one example, alternatively, there is no need to loop over all the combinations, and the combination of which the control points are all refined by TM is directly served as the refined Affine candidate.
      4) In one example, when the refined Affine candidate is derived, a 2^{nd} pass control point refinement may be performed to further refine each control point.
         a) In one example, each CPMV is further iteratively refined to minimize the TM cost of the current block. In each iteration, one CPMV is refined while the others are fixed.
   c) In one example, alternatively, multiple control points are simultaneously refined, where a same MV shift value is shared for all or multiple control points.
      i. In one example, all or partial MV shift values in a given MV shift set are traversed one by one. The MV shift value being traversed is assigned to all or multiple CPMVs, then the motion information of the boundary sub-blocks associated with the refined CPMVs are calculated, and the TM cost is formulated accordingly. In this process, the one that yields the least TM cost is determined as the best motion shift value, which may be finally used to refined the CPMVs.
   d) In one example, the refined Affine candidate may replace the original one.
      i. In one example, the refined Affine candidate will always replace the original one.
      ii. In one example, alternatively, the refined Affine candidate will conditionally replace the original one.
         1) In one example, specifically, the TM costs associated with the original CPMVs (termed as C_beforeTM) and the refined CPMVs (C_afterTM) are respectively calculated, and the refined Affine candidate will replace the original one only when the ratio of C_afterTM and C_beforeTM is smaller (or larger) than a constant or an adaptively determined value TH.
         a) In one example, in above case, different coding modes, e.g., Affine merge/Affine AMVP/Affine MMVD, may have different TH value settings.
      iii. Alternatively, the refined Affine candidate may be used as a new candidate.
         1) In one example, the refined Affine candidate may be placed in a position adjacent to (i.e., right before or after) the original one in the Affine candidate list.
         2) In one example, alternatively, the refined Affine candidates may be placed in arbitrary positions in the Affine candidate list.
         3) In one example, a refined affine candidate may be compared with at least one candidate already in the candidate list. If they are the same or similar, then it is not added into the list.
5. The CPMV refinement may be used with regression based Affine candidate derivation method.
   a) In one example, after all or some of the CPMVs are refined with TM (yielding Affine_model_TM), the motion information of the boundary sub-blocks associated with Affine_model_TM are derived, which is then fed to a regression model to output a new Affine model (termed as Affine_model_R). Then the TM cost of boundary sub-blocks with Affine_model_TM and Affine_model_R are respectively calculated and compared. And the one with less TM cost is determined as the ultimate refined Affine candidate.
      i. In one example, all or some of the CPMVs may firstly perform integer precision TM refinement (yielding Affine_model_TM_I), then perform fractional precision TM refinement (yielding Affine_model_TM_F). And the motion information of the boundary sub-blocks associated with Affine_model_TM_I is derived, which is then fed to a regression model to output a new Affine model (Affine_model_R). Finally, the TM cost of boundary sub-blocks with Affine_model_TM_F and Affine_model_R are calculated and compared, and the one with less TM cost is determined as the ultimate refined Affine candidate.
      ii. In one example, only partial sub-blocks may need to calculate TM cost to generate Affine_model_TM, Affine_model_TM_I and/or Affine_model_TM_F.
6. In one example, TM-based refinement may be applied to affine merge or affine AMVP (affine inter).
   a) In one example, the MVP(s) of affine AMVP may be refined based on TM.
      i. Alternatively, the MVP(s) of affine AMVP may be refined based on DMVR.
7. In one example, TM-based refinement may be applied to an affine-coded block together with DMVR-based refinement.
   a) In one example, TM-based refinement may be applied before DMVR.
   b) In one example, TM-based refinement may be applied after DMVR.
   c) Alternatively, TM-based refinement may be applied to an affine-coded block exclusively with DMVR-based refinement.
8. In one example, derivation of TM cost may depend on whether the block is bi-predicted or uni-predicted.
   a) If the block is bi-predicted, TM cost may be derived based on bi-prediction on TM.
      i. In one example, let TMref0 and TMref1 be the reference TM associated with the List0 and List1 respectively, then the ultimate reference TM (TMbi) may be derived as:

$$TMbi = a * TMref 0 + ( 1 - a ) * TMref 1.$$

1) In one example, a equals to 0.5.
2) In one example, a is determined based on BCW index.
3) In one example, TMref0 is generated based on the CPMVs in List 0, and/or TMref1 is generated based on the CPMVs in List 1.
   b) Alternatively, if the block is bi-predicted, TM cost may be calculated for List0 and List1 separately.
9. In one example, the refinement of CPMVs may be done in an iterative way.
   a) For example, in one step of refinement, one CPMV is refined while others are fixed.
   b) In one example, the already refined CPMV(s) may be used when a subsequent CPMV is to be refined.
      i. In one example, alternatively, the CPMV before refinement is used when the subsequent CPMVs are to be refined.
   c) In one example, the refinement of CPMVs may be done in an iterative way for bi-predicted blocks.
      i. In one example, the CPMVs associated with List K (K=0 or 1) may be firstly refined, then the CPMVs associated with List (1−K) are refined.
         1) Whether to and/or how to refine the CPMVs in a later List (1−K) may be determined based on the refined CPMVs of a former List K.
      ii. In one example, the CPMVs associated with List 0 and List 1 may be separately refined.
         1) In one example, specifically, when the CPMVs in List K (K=0 or 1) are being refined, for each searching step, uni-directional reference TM in List K is generated based on the corresponding CPMVs, and TM cost is hereby calculated to determine the best MV shift value.
      iii. In one example, alternatively, the CPMVs associated with List 0 and List 1 may be jointly refined.
         1) In one example, specifically, when the CPMVs in List K (K=0 or 1) are being refined, for each searching step, bi-directional reference TM is generated based on the CPMV information of both List (as described in Bullet 8). The one yielding the least TM cost is determine as the best MV shift value.
10. Multiple rounds of refinement may be conducted to CPMVs.
   a) In one example, all or partial CPMVs may be refined in each round of refinement.
   b) In one example, all or partial CPMVs may already be refined in a former round refinement, then a later round is conducted to further refine the CPMVs.
11. Whether to and/or how to refine the CPMVs based on TM may be determined based on the prediction direction of the current block.
   a) In one example, the CPMVs may need to be refined by TM only when the current block is uni-predicted.
   b) In one example, the CPMVs may need to be refined by TM only when the current block is bi-predicted.
   c) In one example, the CPMVs may always need to be refined by TM no matter whether the current block is bi-predicted or not.
12. The disclosed methods may be applied to MHP (Multiple hypothesis prediction) coded block if Affine prediction is used as a hypothesis.
13. Whether to and/or how to apply the disclosed methods above may be determined based on syntax element(s).
   a) For example, at least one syntax element is signalled in the bitstream.
   b) For example, whether to and/or how to apply the disclosed methods may be signalled at sequence level/group of pictures level/picture level/slice level/tile group level, such as in sequence header/picture header/SPS/VPS/DPS/DCI/PPS/APS/slice header/tile group header.
   c) For example, whether to and/or how to apply the disclosed methods may be signalled at PB/TB/CB/PU/TU/CU/VPDU/CTU/CTU row/slice/tile/sub-picture/other kinds of region contain more than one sample or pixel.
   d) For example, whether to and/or how to apply the disclosed methods above may be dependent on coded information, such as block size, colour format, single/dual tree partitioning, colour component, slice/picture type.
   e) For example, whether a syntax element (i.e., indicating if TM refinement is applied to CPMVs) is signalled or not may be determined based on another syntax element.

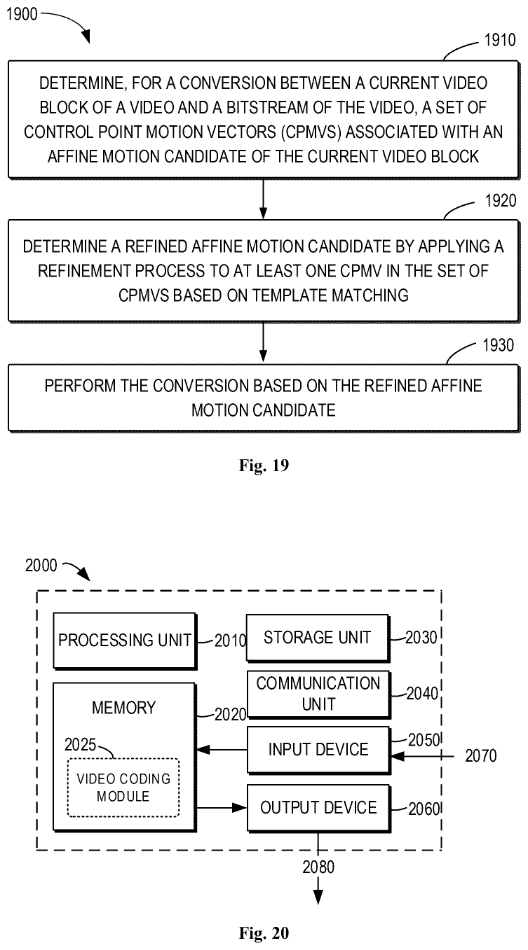

FIG. 19 illustrates a flowchart of a method 1900 for video processing in accordance with embodiments of the present disclosure. The method 1900 may be implemented for a conversion between a current video block of a video and a bitstream of the video.

At block 1910, a set of control point motion vectors (CPMVs) associated with an affine motion candidate of the current video block is determined. At block 1920, a refined affine motion candidate is determined by applying a refinement process to at least one CPMV in the set of CPMVs based on template matching. At block 1930, the conversion is performed based on the refined affine motion candidate.

The method 1900 enables refining the affine motion candidate. For example, the CPMV can be refined. In this way, the coding effectiveness and coding efficiency can be improved.

In some embodiments, the affine motion candidate is replaced by the refined affine motion candidate. That is, the refined Affine candidate may replace the original one. For example, in some embodiments, the refined Affine candidate may always replace the original one.

In some embodiments, whether the affine motion candidate is replaced by the refined affine motion candidate is based on a condition associated with the at least one CPMV. That is, the refined Affine candidate will conditionally replace the original one.

In some embodiments, the condition comprises that a ratio of a first template matching cost of the at least one refined CPMV to a second template matching cost of the at least one CPMV is less than a threshold value.

In some embodiments, the condition comprises that a ratio of a first template matching cost of the at least one refined CPMV to a second template matching cost of the at least one CPMV is greater than a threshold value.

In some embodiments, the threshold value is fixed or determined during the conversion.

In some embodiments, the threshold value is determined based on a coding mode of the current video block.

In some embodiments, a first threshold value for a first coding mode is different from a second threshold value for a second coding mode.

In some embodiments, the coding mode comprises one of: an affine merge mode, an affine advanced motion vector prediction (AMVP) mode, or an affine merge with motion vector difference (MMVD) mode.

In some embodiments, the affine motion candidate is replaced by the refined affine motion candidate based on the condition being satisfied. For example, the TM costs associated with the original CPMVs (termed as C_beforeTM) and the refined CPMVs (C_afterTM) are respectively calculated, and the refined Affine candidate will replace the original one only when the ratio of C_afterTM and C_beforeTM is smaller (or larger) than a constant or an adaptively determined value TH.

In some embodiments, the refined affine motion candidate is used as a new candidate different from the affine motion candidate. That is, the refined Affine candidate may be used as a new candidate.

In some embodiments, the affine motion candidate is in an affine candidate list, and the refined affine motion candidate is placed in a position adjacent to the affine motion candidate in the affine candidate list.

In some embodiments, the refined affine motion candidate is placed in a position right before or after the affine motion candidate in the affine candidate list.

In some embodiments, the affine motion candidate is in an affine candidate list, and the refined affine motion candidate is placed in the affine candidate list. For example, the refined Affine candidates may be placed in arbitrary positions in the Affine candidate list.

In some embodiments, the method 1900 further comprises: determining a difference between the refined affine motion candidate and a further affine motion candidate in an affine candidate list; in accordance with a determination that the difference is less than or equal to a threshold, keeping the affine candidate list without adding the refine motion candidate into the affine candidate list; and in accordance with a determination that the difference is greater than the threshold, adding the refined affine motion candidate in the affine candidate list. In other words, a refined affine candidate may be compared with at least one candidate already in the candidate list. If they are the same or similar, then it is not added into the list.

In some embodiments, the method 1900 further comprises: determining an affine candidate list of the current video block, the affine candidate list comprising a set of affine candidates of the current video block; and applying a CPMV refinement process to at least one affine candidate in the affine candidate list. For example, all or partial Affine candidates need to perform CPMV refinement.

In some embodiments, an affine prediction is used as a hypothesis of the current video block coded with multiple hypothesis prediction (MHP).

In some embodiments, whether to and/or how to apply the method is based on a syntax element in the bitstream.

In some embodiments, the syntax element is at least one of: a sequence level, a group of pictures level, a picture level, a slice level, or a tile group level.

In some embodiments, the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a time group header.

In some embodiments, the syntax element is indicated in a region containing more than one sample or pixel.

In some embodiments, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

In some embodiments, whether to and/or how to apply the method is determined based on coding information of the current video block.

In some embodiments, the coding information comprises at least one of: a block size of the current video block, a color format of the current video block, a single or dual tree partitioning of the current video block, a color component of the current video block, a slice type of the current video block, or a picture type of the current video block.

In some embodiments, whether a first syntax element indicating if a template matching based refinement process is applied to a control point motion vector of the current video block is determined based on a second syntax element.

According to further embodiments of the present disclosure, a non-transitory computer-readable recording medium is provided. The non-transitory computer-readable recording medium stores a bitstream of a video which is generated by a method performed by an apparatus for video processing. In the method, a set of CPMVs associated with an affine motion candidate of a current video block of the video is determined. A refined affine motion candidate is determined by applying a refinement process to at least one CPMV in the set of CPMVs based on template matching. The bitstream is generated based on the refined affine motion candidate.

According to still further embodiments of the present disclosure, a method for storing bitstream of a video is provided. In the method, a set of CPMVs associated with an affine motion candidate of a current video block of the video is determined. A refined affine motion candidate is determined by applying a refinement process to at least one CPMV in the set of CPMVs based on template matching. The bitstream is generated based on the refined affine motion candidate. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, a set of control point motion vectors (CPMVs) associated with an affine motion candidate of the current video block; determining a refined affine motion candidate by applying a refinement process to at least one CPMV in the set of CPMVs based on template matching; and performing the conversion based on the refined affine motion candidate.

Clause 2. The method of clause 1, wherein the affine motion candidate is replaced by the refined affine motion candidate.

Clause 3. The method of clause 1, wherein whether the affine motion candidate is replaced by the refined affine motion candidate is based on a condition associated with the at least one CPMV.

Clause 4. The method of clause 3, wherein the condition comprises that a ratio of a first template matching cost of the at least one refined CPMV to a second template matching cost of the at least one CPMV is less than a threshold value.

Clause 5. The method of clause 3, wherein the condition comprises that a ratio of a first template matching cost of the at least one refined CPMV to a second template matching cost of the at least one CPMV is greater than a threshold value.

Clause 6. The method of clause 4 or 5, wherein the threshold value is fixed or determined during the conversion.

Clause 7. The method of clause 6, wherein the threshold value is determined based on a coding mode of the current video block.

Clause 8. The method of clause 7, wherein a first threshold value for a first coding mode is different from a second threshold value for a second coding mode.

Clause 9. The method of clause 7, wherein the coding mode comprises one of: an affine merge mode, an affine advanced motion vector prediction (AMVP) mode, or an affine merge with motion vector difference (MMVD) mode.

Clause 10. The method of any of clauses 4-9, wherein the affine motion candidate is replaced by the refined affine motion candidate based on the condition being satisfied.

Clause 11. The method of clause 1, wherein the refined affine motion candidate is used as a new candidate different from the affine motion candidate.

Clause 12. The method of clause 11, wherein the affine motion candidate is in an affine candidate list, and the refined affine motion candidate is placed in a position adjacent to the affine motion candidate in the affine candidate list.

Clause 13. The method of clause 12, wherein the refined affine motion candidate is placed in a position right before or after the affine motion candidate in the affine candidate list.

Clause 14. The method of clause 11, wherein the affine motion candidate is in an affine candidate list, and the refined affine motion candidate is placed in the affine candidate list.

Clause 15. The method of clause 11, further comprising: determining a difference between the refined affine motion candidate and a further affine motion candidate in an affine candidate list; in accordance with a determination that the difference is less than or equal to a threshold, keeping the affine candidate list without adding the refine motion candidate into the affine candidate list; and in accordance with a determination that the difference is greater than the threshold, adding the refined affine motion candidate in the affine candidate list.

Clause 16. The method of any of clauses 1-15, further comprising: determining an affine candidate list of the current video block, the affine candidate list comprising a set of affine candidates of the current video block; and applying a CPMV refinement process to at least one affine candidate in the affine candidate list.

Clause 17. The method of any of clauses 1-16, wherein an affine prediction is used as a hypothesis of the current video block coded with multiple hypothesis prediction (MHP).

Clause 18. The method of any of clauses 1-17, wherein whether to and/or how to apply the method is based on a syntax element in the bitstream.

Clause 19. The method of clause 18, wherein the syntax element is at least one of: a sequence level, a group of pictures level, a picture level, a slice level, or a tile group level.

Clause 20. The method of clause 18 or clause 19, wherein the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a time group header.

Clause 21. The method of any of clauses 18-20, wherein the syntax element is indicated in a region containing more than one sample or pixel.

Clause 22. The method of clause 21, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

Clause 23. The method of any of clauses 1-22, wherein whether to and/or how to apply the method is determined based on coding information of the current video block.

Clause 24. The method of clause 23, wherein the coding information comprises at least one of: a block size of the current video block, a color format of the current video block, a single or dual tree partitioning of the current video block, a color component of the current video block, a slice type of the current video block, or a picture type of the current video block.

Clause 25. The method of any of clauses 1-24, wherein whether a first syntax element indicating if a template matching based refinement process is applied to a control point motion vector of the current video block is determined based on a second syntax element.

Clause 26. The method of any of clauses 1-25, wherein the conversion includes encoding the current video block into the bitstream.

Clause 27. The method of any of clauses 1-25, wherein the conversion includes decoding the current video block from the bitstream.

Clause 28. An apparatus for video processing comprising a processor and a non-transitory memory with instructions thereon, wherein the instructions upon execution by the processor, cause the processor to perform a method in accordance with any of clauses 1-27.

Clause 29. A non-transitory computer-readable storage medium storing instructions that cause a processor to perform a method in accordance with any of clauses 1-27.

Clause 30. A non-transitory computer-readable recording medium storing a bitstream of a video which is generated by a method performed by an apparatus for video processing, wherein the method comprises: determining a set of control point motion vectors (CPMVs) associated with an affine motion candidate of a current video block of the video; determining a refined affine motion candidate by applying a refinement process to at least one CPMV in the set of CPMVs based on template matching; and generating the bitstream based on the refined affine motion candidate.

Clause 31. A method for storing a bitstream of a video, comprising: determining a set of control point motion vectors (CPMVs) associated with an affine motion candidate of a current video block of the video; determining a refined affine motion candidate by applying a refinement process to at least one CPMV in the set of CPMVs based on template matching; generating the bitstream based on the refined affine motion candidate; and storing the bitstream in a non-transitory computer-readable recording medium.

### Example Device

FIG. 20 illustrates a block diagram of a computing device 2000 in which various embodiments of the present disclosure can be implemented. The computing device 2000 may be implemented as or included in the source device 110 (or the video encoder 114 or 200) or the destination device 120 (or the video decoder 124 or 300).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010, a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to, volatile and non-volatile medium, or detachable and non-detachable medium. The memory 2020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2030 may be any detachable or non-detachable medium and may include a machine-readable medium such as a memory, flash memory drive, magnetic disk or another other media, which can be used for storing information and/or data and can be accessed in the computing device 2000.

The computing device 2000 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers, networked personal computers (PCs) or further general network nodes.

The input device 2050 may be one or more of a variety of input devices, such as a mouse, keyboard, tracking ball, voice-input device, and the like. The output device 2060 may be one or more of a variety of output devices, such as a display, loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement video encoding/decoding in embodiments of the present disclosure. The memory 2020 may include one or more video coding modules 2025 having one or more program instructions. These modules are accessible and executable by the processing unit 2010 to perform the functionalities of the various embodiments described herein.

In the example embodiments of performing video encoding, the input device 2050 may receive video data as an input 2070 to be encoded. The video data may be processed, for example, by the video coding module 2025, to generate an encoded bitstream. The encoded bitstream may be provided via the output device 2060 as an output 2080.

In the example embodiments of performing video decoding, the input device 2050 may receive an encoded bitstream as the input 2070. The encoded bitstream may be processed, for example, by the video coding module 2025, to generate decoded video data. The decoded video data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a set of control point motion vectors (CPMVs) associated with an affine motion candidate of the current video block;
determining a refined affine motion candidate by applying a refinement process to at least one CPMV in the set of CPMVs based on template matching; and
performing the conversion based on the refined affine motion candidate.

2. The method of claim 1, wherein the affine motion candidate is replaced by the refined affine motion candidate.

3. The method of claim 1, wherein whether the affine motion candidate is replaced by the refined affine motion candidate is based on a condition associated with the at least one CPMV.

4. The method of claim 3, wherein the condition comprises that a ratio of a first template matching cost of the at least one refined CPMV to a second template matching cost of the at least one CPMV is less than a threshold value, or
wherein the condition comprises that a ratio of a first template matching cost of the at least one refined CPMV to a second template matching cost of the at least one CPMV is greater than a threshold value.

5. The method of claim 4, wherein the threshold value is fixed or determined during the conversion, or wherein the threshold value is determined based on a coding mode of the current video block.

6. The method of claim 5, wherein a first threshold value for a first coding mode is different from a second threshold value for a second coding mode,
wherein the coding mode comprises one of: an affine merge mode, an affine advanced motion vector prediction (AMVP) mode, or an affine merge with motion vector difference (MMVD) mode.

7. The method of claim 4, wherein the affine motion candidate is replaced by the refined affine motion candidate based on the condition being satisfied.

8. The method of claim 1, wherein the refined affine motion candidate is used as a new candidate different from the affine motion candidate.

9. The method of claim 8, wherein the affine motion candidate is in an affine candidate list, and the refined affine motion candidate is placed in a position adjacent to the affine motion candidate in the affine candidate list, wherein the refined affine motion candidate is placed in a position right before or after the affine motion candidate in the affine candidate list, or
wherein the affine motion candidate is in an affine candidate list, and the refined affine motion candidate is placed in the affine candidate list.

10. The method of claim 8, further comprising:
determining a difference between the refined affine motion candidate and a further affine motion candidate in an affine candidate list;
in accordance with a determination that the difference is less than or equal to a threshold, keeping the affine candidate list without adding the refine affine motion candidate into the affine candidate list; and
in accordance with a determination that the difference is greater than the threshold, adding the refined affine motion candidate in the affine candidate list.

11. The method of claim 1, further comprising:
determining an affine candidate list of the current video block, the affine candidate list comprising a set of affine candidates of the current video block; and
applying a CPMV refinement process to at least one affine candidate in the affine candidate list.

12. The method of claim 1, wherein an affine prediction is used as a hypothesis of the current video block coded with multiple hypothesis prediction (MHP).

13. The method of claim 1, wherein whether to and/or how to apply the method is based on a syntax element in the bitstream,
wherein the syntax element is at least one of: a sequence level, a group of pictures level, a picture level, a slice level, or a tile group level, or
wherein the syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

14. The method of claim 13, wherein the syntax element is indicated in a region containing more than one sample or pixel, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

15. The method of claim 1, wherein whether to and/or how to apply the method is determined based on coding information of the current video block, wherein the coding information comprises at least one of: a block size of the current video block, a color format of the current video block, a single or dual tree partitioning of the current video block, a color component of the current video block, a slice type of the current video block, or a picture type of the current video block.

16. The method of claim 1, wherein whether a first syntax element is included in the bitstream is determined based on a second syntax element, the first syntax element indicating if a template matching based refinement process is applied to a control point motion vector of the current video block.

17. The method of claim 1, wherein the conversion includes encoding the current video block into the bitstream, or
wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, a set of control point motion vectors (CPMVs) associated with an affine motion candidate of the current video block;
determine a refined affine motion candidate by applying a refinement process to at least one CPMV in the set of CPMVs based on template matching; and
perform the conversion based on the refined affine motion candidate.

19. A non-transitory computer-readable storage medium storing instructions that cause a processor to perform a method comprising:
determining, for a conversion between a current video block of a video and a bitstream of the video, a set of control point motion vectors (CPMVs) associated with an affine motion candidate of the current video block;
determining a refined affine motion candidate by applying a refinement process to at least one CPMV in the set of CPMVs based on template matching; and
performing the conversion based on the refined affine motion candidate.

20. A non-transitory computer-readable recording medium storing a bitstream of a video which is generated by a method performed by an apparatus for video processing, wherein the method comprises:
determining a set of control point motion vectors (CPMVs) associated with an affine motion candidate of a current video block of the video;
determining a refined affine motion candidate by applying a refinement process to at least one CPMV in the set of CPMVs based on template matching; and
generating the bitstream based on the refined affine motion candidate.
